(19) United States
(12) Patent Application Publication
(10) Pub. No.: US 2013/0097092 A1
(43) Pub. Date: Apr. 18, 2013

(54) UNCLAIMED PROPERTY METHOD AND SYSTEM

(71) Applicants: Brian Tully, Hoboken, NJ (US); Michael Tenderenda, Garfield, NJ (US); Kathleen Moyer, Dover, FL (US); Brad Jowers, Ponder, TX (US); Teresita M. Ventresca, Skippack, PA (US); Josiah Osibodu, Tampa, FL (US)

(72) Inventors: Brian Tully, Hoboken, NJ (US); Michael Tenderenda, Garfield, NJ (US); Kathleen Moyer, Dover, FL (US); Brad Jowers, Ponder, TX (US); Teresita M. Ventresca, Skippack, PA (US); Josiah Osibodu, Tampa, FL (US)

(21) Appl. No.: 13/334,182

(22) Filed: Dec. 22, 2011

Related U.S. Application Data
(60) Provisional application No. 61/437,091, filed on Jan. 28, 2011.

(51) Int. Cl. G06Q 30/00; G06Q 50/26

(52) U.S. Cl. CPC G06Q 30/018; G06Q 50/26
USPC 705/317

(57) ABSTRACT

Systems and techniques are disclosed that provide automation for the Unclaimed Property (Escheat) process. The systems and technique provide a complete ‘end to end’ solution for the unclaimed property compliance process including tracking of potential unclaimed transactions, mailing of confirmation and due diligence letters, routing responses received from the letters, and the preparation of the unclaimed property reports. In the event of a state unclaimed property audit, the solution's electronic document repository creates an ‘audit ready’ environment by providing easy access to documents including confirmation letters, documents supporting the removal of the transactions from the unclaimed property process, state required due diligence letters, and state unclaimed property reports.

### CROSS-REFERENCE TO RELATED APPLICATION

This application claims priority to U.S. Provisional Application No. 61/437,091 filed Jan. 28, 2011 entitled ‘Unclaimed Property Method and System’, the content of which is incorporated herein in its entirety.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2011, Thomson Reuters.

### TECHNICAL FIELD

The present invention relates to accounting transactions and more particularly, accounting transactions subject to unclaimed property laws.

### BACKGROUND

In the United States, each state has abandoned or unclaimed property laws that allow the state to claim abandoned property from various financial institutions on an annual basis after a specific amount of time has passed. Abandoned or unclaimed property can range from bank accounts and safe deposit box holdings to stocks and bonds. Unclaimed property can be any financial asset that is due and owing to another party, i.e. a customer, vendor, employee, investor, etc.

By virtue of state laws, if unclaimed property assets cannot be returned to the rightful owner, the asset must be reported and remitted to the state in which the owner was last known to live once a “dormancy period” for the particular type of asset has expired. Typically, the dormancy period is three to five years, but varies from state to state.

To manage unclaimed property, institutions typically use Excel® spreadsheets, MS Office® calendar tools, and general ledger tools to track how unclaimed property is created from the accounts payable, accounts receivable and other financial/property information. These tools, however, tend to be tedious and time consuming to use for these purposes. Further, as a result of the current economic downturn and the growth of state budget deficits, states are becoming increasingly aggressive in their pursuit of unclaimed property and their audits of companies not in compliance with the law.

Accordingly, there is a need for a new tool and process that can automate the management of unclaimed property information.

### SUMMARY

Systems and techniques are disclosed that provide automation for the unclaimed property (Escheat) process. The systems and technique provide a complete ‘end to end’ solution for the unclaimed property compliance process including tracking of potential unclaimed transactions, mailing of confirmation and due diligence letters, routing responses received from the letters, and the preparation of the unclaimed property reports. An electronic document repository is also provided that provides easy access to documents including confirmation letters, documents supporting the removal of the transactions from the unclaimed property process, state required due diligence letters, and state unclaimed property reports.

Various aspects of the invention relate to providing electronic workflows for association with potentially unclaimed assets and generating unclaimed property forms for submission to governmental authorities.

For example, according to one aspect, a method of managing unclaimed property includes providing an electronic workflow for association with a potentially unclaimed asset associated with an entity. The electronic workflow includes a set of pre-defined procedures for processing the potentially unclaimed asset. Based upon completion of at least one procedure from the set of pre-defined procedures, the method includes determining whether a communication with a governmental authority is necessary. If the communication is necessary, the method includes automatically generating a set of unclaimed property forms for submission to the governmental authority, and if the communication is unnecessary, the method includes automatically terminating the electronic workflow.

In another aspect, a system for managing unclaimed property includes a set of pre-defined procedures for processing a potentially unclaimed asset associated with an entity. The system includes a workflow module to manage and execute at least one procedure of the set of pre-defined procedures, and a filing module to generate a set of unclaimed property forms for submission to a governmental authority.

In one embodiment, the system further includes a document module to associate a document with at least one procedure of the set of pre-defined procedures, and an interface module that provides a graphical user interface for completing the at least one procedures of the set of pre-defined procedures.

Additional systems, methods, as well as articles that include a machine-readable medium storing machine-readable instructions for implementing the various techniques, are disclosed. Details of various embodiments are discussed in greater detail below.

### BRIEF DESCRIPTION OF THE DRAWINGS

FIG. 1 is a schematic of an exemplary computer-based system for managing unclaimed property according to one embodiment of the present invention.

FIG. 2 illustrates an exemplary method of processing an accounting transaction according to one embodiment of the present invention.

FIG. 3 illustrates an exemplary set of pre-defined procedures for processing an unclaimed transaction according to one embodiment of the present invention.

FIGS. 4-23 illustrate examples of graphical user interfaces for use with the system shown in connection with FIG. 1.

### DETAIL DESCRIPTION

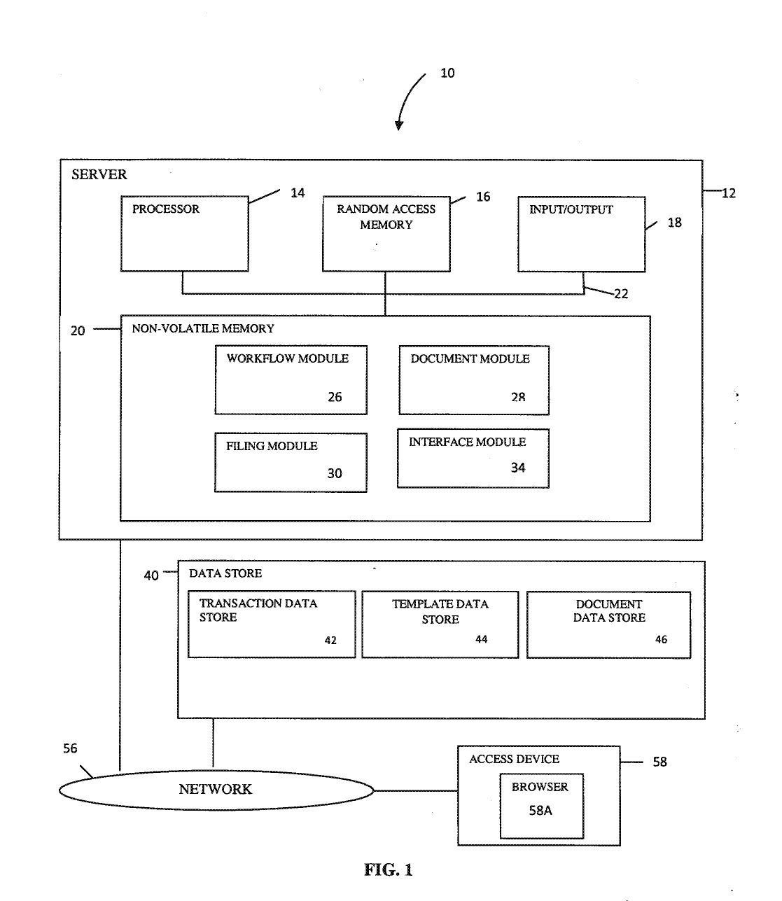

FIG. 1 is a schematic of a suitable computer system 10 within which embodiments of the present invention may be implemented. The computer system 10 is only one example and is not intended to suggest any limitation as to the scope of use or functionality of the invention. Neither should the computer system 10 be interpreted as having any dependency or requirement relating to any one or combination of illustrated components.

For example, the present invention is operational with numerous other general purpose or special purpose computers, consumer electronics, network PCs, minicomputers, mainframe computers, laptop computers, as well as distributed computing environments that include any of the above systems or devices, and the like.

The invention may be described in the general context of computer-executable instructions, such as program modules, being executed by a computer. Generally, program modules include routines, programs, objects, components, data structures, loop code segments and constructs, etc. that perform particular tasks or implement particular abstract data types. The invention may be practiced in distributed computing environments where tasks are performed by remote processing devices that are linked through a communications network. In a distributed computing environment, program modules are located in both local and remote computer storage media including memory storage devices. Tasks performed by the programs and modules are described below and with the aid of figures. Those skilled in the art may implement the description and figures as processor executable instructions, which can be written on any form of a computer readable media.

The system 10 shown in FIG. 1 provides a technology based solution for processing accounting transactions subject to States' Unclaimed Property (Escheat) Laws. The system 10 may be used to determine whether an asset, represented by an accounting transaction, outstanding for a certain number of days requires remediation, is to be returned to a rightful owner, or reported to a state as unclaimed property.

The system 10 provides enhanced controls to determine the status of each transaction at any point in time during a confirmation process (e.g., 90 to 365 days outstanding) as well as a unclaimed property compliance process (e.g., post 365 days). Asset transactions processed by the system 10 may include outstanding payroll checks, accounts payable checks, customer refund checks, and any other form of disbursement. In various embodiments, the asset transactions include customer accounts receivable credit balances, unidentified remittances and unapplied cash. In one embodiment, the system 10 processes accounts receivable credit balances that are reduced to a “fixed and certain obligation” and that remain unchanged over a period of time.

Examples of unclaimed property assets processed by the system, 10 include, but are not limited to, uncashed checks (payroll, accounts payable, commissions, rebates, etc.), accounts receivable credit balances and refunds, gift cards/certificates, insurance proceeds, the contents of safe deposit boxes rented by financial institutions, money orders, travelers checks, utility deposits, securities and related property, mineral proceeds and interest, and the like.

The system 10 may assign a role to one or more role implementers (e.g., an individual, plurality of individuals, or system role) that are assigned to tasks (e.g., procedures) in a process (e.g., a set of pre-defined procedures), and generate notifications if one or more assigned tasks are not completed timely. The system 10 may also provide an audit trail for the ultimate disposition of outstanding transactions. In one embodiment, various components of the system 10 are implemented as a .NET application and use a workflow module, such as the ONESOURCE WorkFlow Manager provided by Thomson Reuters, for tracking of tasks, assignments, due dates, and task routing to roles. The system may also include a document management capability that results in a central data repository for all information related to the unclaimed property (escheat) process.

Advantageously, the system 10 is capable of determining the status of each accounting transaction at any point in time during the process. For example, in one embodiment, the system 10 provides an audit trail for the ultimate disposition of outstanding accounting transactions, and an electronic repository for supporting documentation. The system 10 may assign accountability for each pre-defined procedure associated with the confirmation process and compliance process, and generate notifications if assigned procedures are not completed timely. In one embodiment, the electronic repository includes unclaimed property reports (e.g., generated forms) generated by the system, one or more checklists for confirming transfer agent compliance activities relating to equity-related property, as well as checklists that may be used for newly integrated businesses, acquisitions and divestitures.

Advantageously, the system 10 may be configured to create an “audit ready” environment in the event of any state unclaimed property audit, and to provide a complete “end to end solution” for the unclaimed property compliance process that includes tracking of potential unclaimed transactions, documentation of ultimate disposition of outstanding transactions, automatic transmitting of confirmation and due diligence letters, preparation of state unclaimed property reports in required format, as well as payments to the respective states.

As shown in FIG. 1, in one embodiment, the system 10 includes a server device 12 configured to include a processor 14, such as a central processing unit (‘CPU’), random access memory (‘RAM’) 16, one or more input-output devices 18, such as a display device (not shown) and keyboard (not shown), and non-volatile memory 20, all of which are interconnected via a common bus 22 and controlled by the processor 14.

The non-volatile memory 20 is configured to include a workflow module 26 that manages and executes one or more pre-defined procedures for processing unclaimed accounting transactions. This may include instantiating workflow processes, routing tasks to roles identified in workflow processes, as well as modify workflow processes (e.g. delete or reorder tasks in a process).

The non-volatile memory 20 is also configured to include a document module 28 that associates one or more documents (e.g., communications, notes, checklists) with pre-defined procedures, a filing module 30 that generates unclaimed property forms for submission to a governmental authority, such as a state, and an interface module 34 that provides a graphical user interface for processing one or more of the pre-defined procedures. Additional details of each of the modules 26, 28, 30, and 34 are discussed in further detail below.

As shown in FIG. 1, a network 56 is provided that can include various devices such as routers, server, and switching elements connected in an Intranet, Extranet or Internet configuration. In one embodiment, the network 56 uses wired communications to transfer information between an access device 58, the server device 12, and a data store 40. In another embodiment, the network 56 employs wireless communication protocols to transfer information between the access device 58, the server device 12, and the data store 40. In yet other embodiments, the network 56 employs a combination of wired and wireless technologies to transfer information between the access device 58, the server device 12, and the data store 40.

The access device 58 may include a personal computer, laptop computer, or other type of electronic device, such as a cellular phone or Personal Digital Assistant (PDA). In one embodiment, for example, the access device 58 is coupled to I/O devices (not shown) that include a keyboard in combination with a pointing device such as a mouse for sending web page requests to the server device 12. Preferably, memory of the access device 58 is configured to include a web browser 58A that is used to request and receive information from the server 12. Although only one access device 58 is shown in FIG. 1, the system 10 may support multiple access devices.

The data store 40 is a repository that maintains and stores information utilized by the before-mentioned modules. In one embodiment, the data store 40 is a relational database. In another embodiment, the data store 40 is a directory server, such as a Lightweight Directory Access Protocol (‘LDAP’). In yet another embodiment, the data store 40 is an area of non-volatile memory 20 of the server 12.

In one embodiment, as shown in the FIG. 1 example, the data store 40 includes a transaction data store 42. The transaction data store 42 stores asset information from source systems in which analysis is desired. In one embodiment, for example, the system (10) schedules and automatically downloads asset transactions from one or more source systems that may include, but are not limited to, payroll data, accounts receivable data, accounts payable data, and garnishment data.

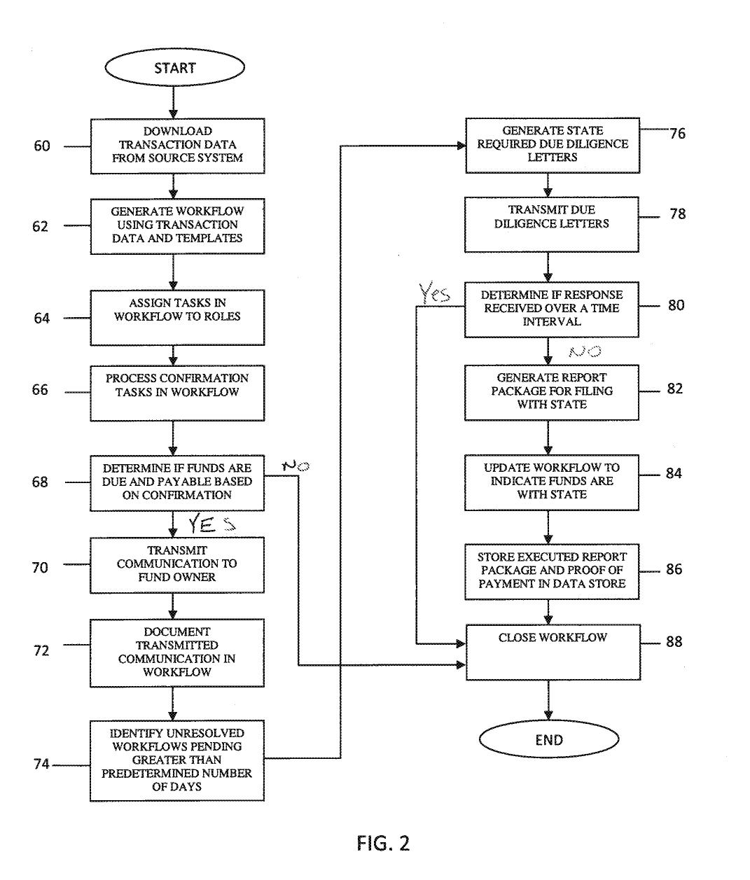

A template data store 44 is provided that defines a set of pre-defined procedures that are to be executed to process potentially unclaimed property. The set of pre-defined procedures are utilized by the workflow module 26 to instantiate a workflow process, which is discussed in connection with FIG. 2.

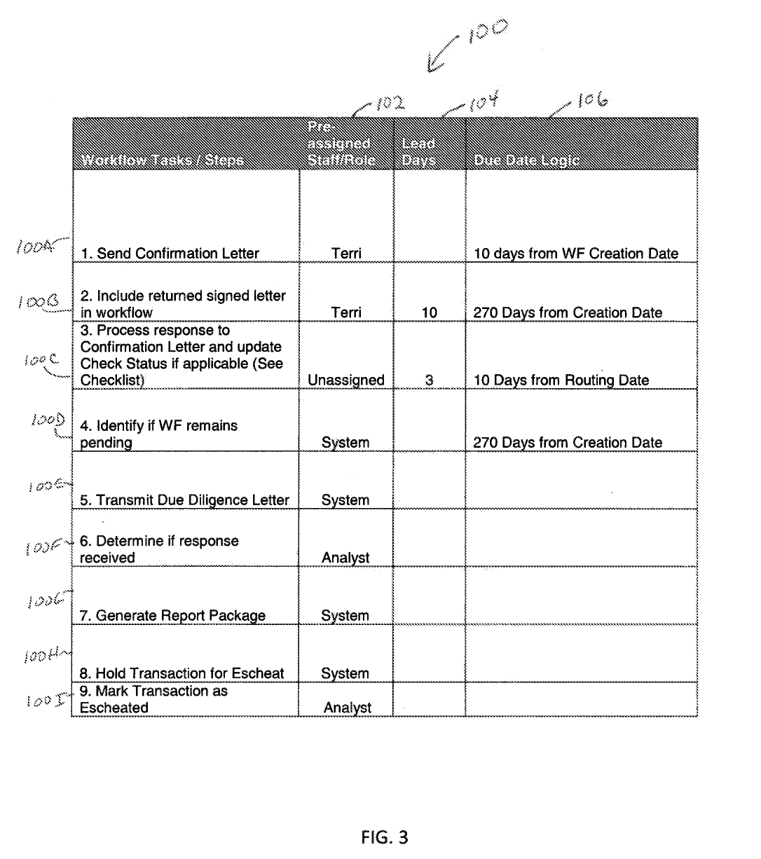

An example set of pre-defined procedures 100 relating to processing of payroll transaction data is shown in connection with FIG. 3. As shown in the FIG. 3 example, in one embodiment, the set of pre-defined procedures 100 define individual procedures (e.g., tasks) 100A-I that may be assigned to roles 102 for task accountability. In one embodiment, the roles 102 are associated with a role implementer, which may be an individual, a group of individuals, or a system for automated processing. If the role implementer is an individual or group of individuals, the automatic generation of forms and automatic termination of one or more tasks still occurs. Although the tasks 100A-I shown in FIG. 3 are listed sequentially, the present invention is not limited to processing tasks in a sequential fashion and other sets of pre-defined procedures may include tasks that are to be executed in parallel.

As shown in the FIG. 3, each task 100A-I also may be associated with a lead time 104, indicating when the task is to be initiated, and a due time 106, indicating when the task beneficially should be completed. The workflow module 26 uses these times 104, 106 to route tasks to roles 102 and automatically trigger actions as may be required by each of the procedures 100A-I.

Referring back to FIG. 1, the data store 40 may also include a document data store 46. The document data store 46 may be utilized to store correspondence, supporting documentation, electronic notes, and electronic checklists associated with one or procedures included in a workflow process. In one embodiment, the document data store 46 is utilized to store generated forms and reports generated by the filing module 30, as well as system statistic reports generated by the workflow module 26.

Although the data store 40 shown in FIG. 1 is connected to the network 56, it will be appreciated by one skilled in the art that the data store 40 and/or any of the information shown therein, can be distributed across various servers and be accessible to the server 12 over the network 56, be coupled directly to the server 12, or be configured in an area of non-volatile memory 20 of the server 12.

Further, it should be noted that the system 10 shown in FIG. 1 is only one embodiment of the disclosure. Other system embodiments of the disclosure may include additional structures that are not shown, such as secondary storage and additional computational devices. In addition, various other embodiments of the disclosure include fewer structures than those shown in FIG. 1. For example, in one embodiment, the disclosure is implemented on a single computing device in a non-networked standalone configuration. Data input and requests are communicated to the computing device via an input device, such as a keyboard and/or mouse. Data output, such as the computed significance score, of the system is communicated from the computing device to a display device, such as a computer monitor.

Turning now to FIG. 2, an example method of processing unclaimed property according to one embodiment is disclosed. The example method described relates to processing an unclaimed fund, but is also applicable to other types of unclaimed property. As shown in the FIG. 2 example, at step 60, transaction data is first downloaded from a source system into the transaction data store 42. The transaction data may relate to various types of unclaimed property, as described previously, and may be considered the first task in a confirmation process. Next at step 62, the workflow module 26 generates (e.g., instantiates) a workflow process from a set of one or more pre-defined procedures included in the template data store 44. The instantiated workflow process represents one or more tasks that are to be completed. In one embodiment, the workflow module 26 determines the set of pre-defined procedures based on characteristics associated with the downloaded transaction data. Next at step 64, the workflow module 26 may assign one or more tasks included in the workflow process to roles defined in the system 10. As described previously, roles may be associated with a role implementer, which may be an individual, a plurality of individuals, or a system role.

Next, at step 66, the workflow module 26 tracks one or more tasks to confirm whether the potentially unclaimed asset is an unclaimed asset. The one or more tasks may include research tasks to confirm that the transaction remains outstanding. For example, in one embodiment, as shown at step 68, if it is determined that the asset is not outstanding, the workflow module 26 automatically terminates the workflow process, as indicated at step 88. Otherwise, if it is determined that the asset remains outstanding (for example, due and payable), as indicated at step 70, the workflow module 26 transmits a communication to a last identified owner of the fund. In one embodiment, the document module 28 generates the communication and the workflow module 26 transmits the communication electronically to the last identified owner via email or facsimile. In another embodiment, the document module 28 generates the communication, and a role implementer assigned to that particular task sends the communication using a postal service.

Next, at step 72, the document module 28 associates the communication and any response related thereto, with one or more tasks and stores the same in the document data store 46. The communication or response may be an email, a Portable Document Format (PDF) file, an excel file, or any other type of correspondence, and be used as support in the event of a state unclaimed property audit. The document module 28 may also provide one or more checklists that may be utilized by a user of the system to ensure that standardized procedures are followed, and associate the one or more checklists with tasks in the workflow process. Further, in one embodiment, the document module 28 associates any notes that may be entered by a user with one or more tasks in the workflow process.

Next, at step 74, the workflow module 26 identifies any workflow processes that are pending greater than a predetermined number of days. For example, in one embodiment, the predetermined number of days is set to three hundred and sixty five (365) days and is considered a first user task of a compliance process.

Next, at step 76, the filing module 30 generates one or more state mandated due diligence letters. Notably, the requirements of state due diligence letters may vary from state to state. Advantageously, the data store 40 of the present invention maintains these state requirements. Next at step 78, the workflow module 26 transmits the one or more generated due diligence letters via email or facsimile to the last identified owner, and then determines whether a response to the one or more diligence letters has been received over a time interval. In one embodiment, the one or more generated due diligence letters are mailed to the last identified owner and the workflow module 26 determines whether a response is received over the time interval. If a response to the due diligence letters is received, the workflow module 26, at step 88, automatically terminates the workflow process. Otherwise, as shown in step 82, the filing module 30 automatically generates a report package (e.g., a set of unclaimed property forms) for filing with the state. Advantageously, the system 10 maintains in the data store 40 report package requirements for each state. Once the report package is transmitted to the state, either electronically by the workflow module 26 or by a user of the system via a postal service, the workflow module 26, at step 84, updates the workflow process to indicate that the asset has been transmitted to the state. Lastly, at step 86, the filing module 30 stores the generated report package in the document data store 40, which may be accessed in a seamless fashion.

Advantageously, by using the above-described system and method, institutions may reduce their unclaimed property liability and significantly minimize potential unclaimed property audit costs and assessments.

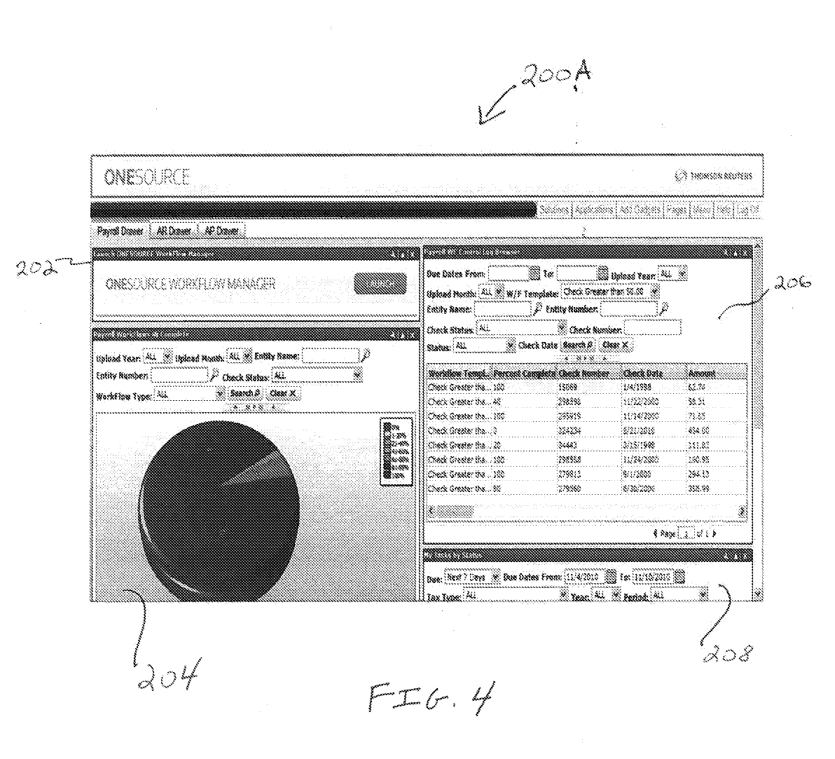

FIGS. 4-23 illustrate example screens 200A-T of the graphical user interface provided by the interface module 34. In one embodiment, one or more of the example screens 200A-T are displayed on the browser 58A of the access device 58 using a web server.

FIG. 4 illustrates a dashboard screen 200A that may be displayed to a user by the interface module 34 upon logging into the system 10. As shown in FIG. 4, the dashboard screen 200A includes a graphic portion 204 indicating a percentage of workflow processes completed and pending for the user, a control portion 206 that indicates for each workflow process associated with the user a percentage of tasks completed, and a query option 208 allowing the user to query tasks assigned to the user by due date and asset type.

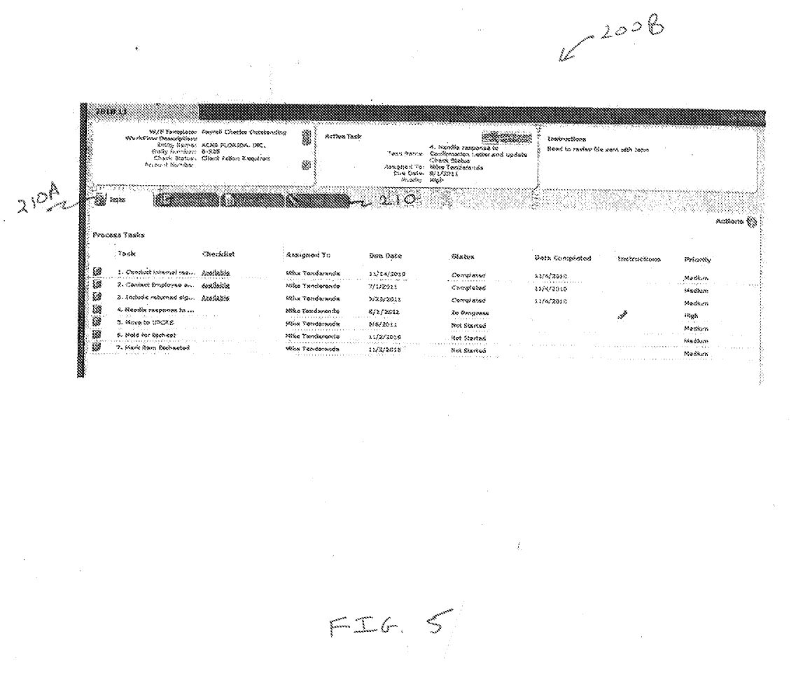

FIG. 5 illustrates an example workflow screen 200B that may be displayed to the user by the interface module 34 upon selection of one workflow process displayed in the control portion 206 shown in FIG. 4. As shown in the FIG. 5 example, the workflow screen 200B includes a plurality of selectable tabs 210 for displaying information relating to process tasks, documents associated with tasks, checklists associated with tasks, and notes associated with tasks. In one embodiment, as shown in FIG. 5, upon selection of a task tab 210A included in the plurality of tabs 210, a task name, checklist hyperlink, role implementer, due date, task status, completion date, instructions and priority are displayed for one or more tasks included in the workflow process.

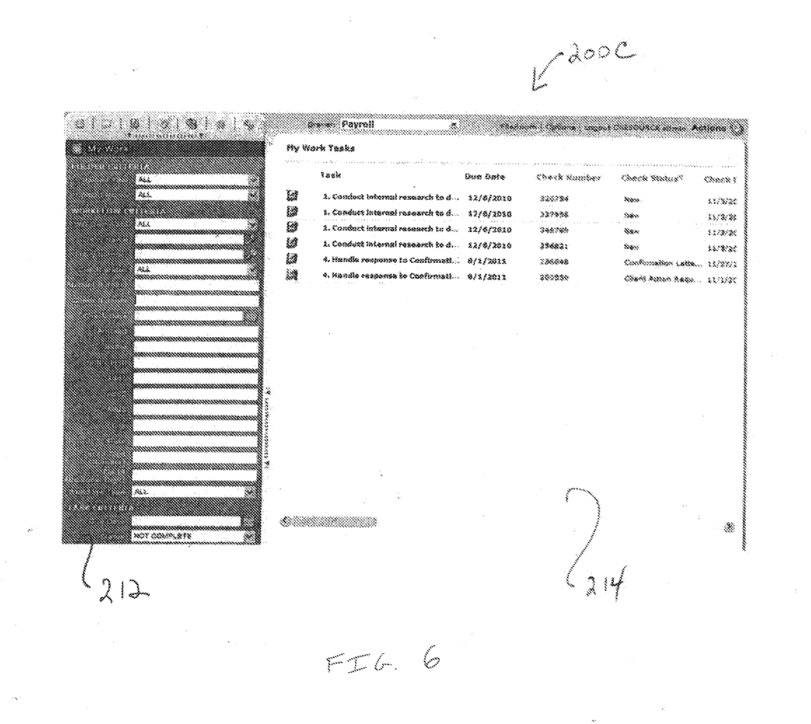

FIG. 6 illustrates an example My Work screen 200C that may be displayed to the user by the interface module 34. The My Work screen 200C includes a task display portion 214 that shows all tasks assigned to the user across multiple workflow processes. A criteria portion 212 is also provided in the screen 200C that allows the user to configure a view of the task display portion 214 using search fields. Using the My Work screen 200C, the user may view, edit, and track assigned tasks and events, enter search criteria to customize the task display portion 214, and open a workflow process associate with a task.

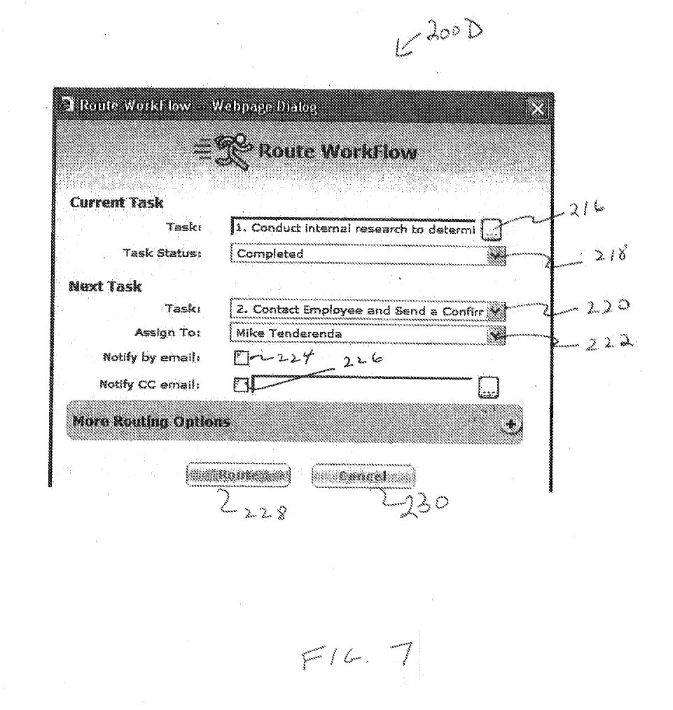

FIG. 7 illustrates a routing screen 200D that may be displayed to the user by the interface module 34. The routing screen 200D allows a user to specify a task status that is to be associated with an active task of a workflow process, and indicate the role implementer to which a subsequent task in the workflow is to be assigned. As shown in the FIG. 7 example, the routing screen 200D may include a task selection identifier 216 and task status identifier 218 for specifying which task of a workflow process is to be set to a particular status, and what system actions are to be taken for subsequent tasks. As shown in the FIG. 7 example, a task pull-down menu 220 may be provided to select a next task in the workflow process, an assign pull-down menu 222 may be provided that allows the user to select a role implementer, as well as checkboxes 224, 226 that, upon selection of a provided route button 228, cause the workflow module 28 to notify one or more role implementers that a next task in the workflow process is now assigned to them. A cancel button 230 may also be provided that closes the routing screen 200D.

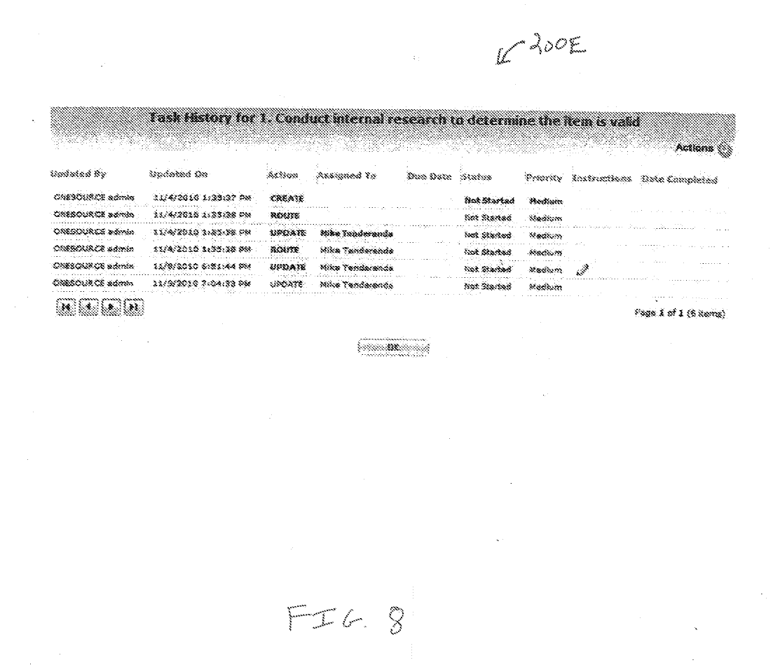

FIG. 8 illustrates an example task history screen 200E provided by the interface module 34. The task history screen 200E provides a display only view of activity performed on tasks. For example, as shown in FIG. 8, in one embodiment, the task history screen 200E indicates what user updated a task, when the update occurred, action taken on the task, what role integrator acted upon the task, as well as any due date, priority, instructions, or completion dates associated with the task.

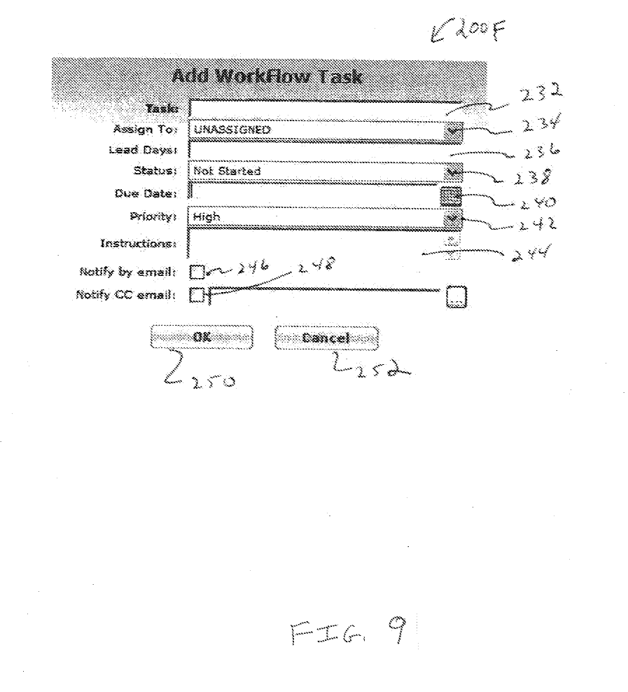

FIG. 9 illustrates an add task screen 200F provided by the interface module 34. The add task screen 200F allows the user of the system 10 to specify one or more additional tasks that are to be assigned to a workflow process. As shown in the FIG. 9 example, in one embodiment, the following options may be specified which are applied by the workflow module 26: task name 232, role integrator 234, lead days 236, status 238, due date 240, priority 242, and instructions 244. As shown in the FIG. 9 example, checkboxes 246, 248 are also provided. Upon a selection of one of the checkboxes 246, 248 and an OK button 250 provided in the screen 200F, the workflow module 26 adds a task with the before-mentioned options to an existing workflow process. A close button 252 is also provided that once selected, closes the add task screen 200F.

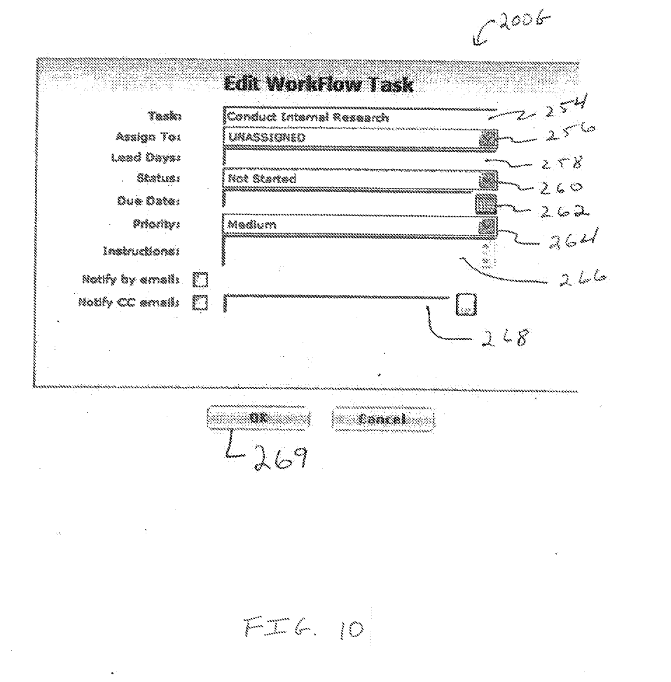

FIG. 10 illustrates an example edit task screen 200G provided by the interface module 34. The edit task screen 200G allows the user of the system 10 with proper permissions to make adjustments to instantiated process tasks upon selection of a provided OK button 269. In one embodiment, as shown in FIG. 10, the user may update a task name, reassign the task to a role implementer, update lead days, status, due date, and priority associated with the task, as well as specify instructions and notification recipients that are to be notified concerning any changes made to the task via functional boxes 254, 256, 258, 260, 262, 264, 266, and 268, respectively.

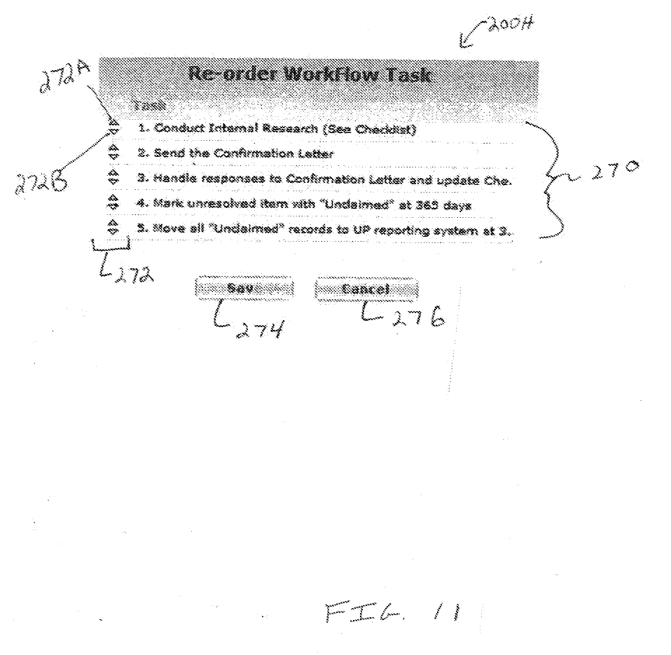

FIG. 11 illustrates an example task reorder screen 200H provided by the interface module 33. As shown in the FIG. 1 example, the screen 200H provides a list of tasks 270 associated with a workflow process and controls 272 associated with each task of the list of tasks 270. The controls 272 allow the user to modify the sequence in which tasks are to be executed in a workflow process. For example, in one embodiment, each control 272 includes a selectable up option 272A and down option 272B. Upon selection of the up option 272A or down option 272B associated with a task and selection of a provided save button 274, the workflow module 26 modifies the workflow process to cause the task to be moved prior to or subsequent to other tasks included in the list of tasks 270, respectively. A close button 276 is also provided that closes the task reorder screen 200H.

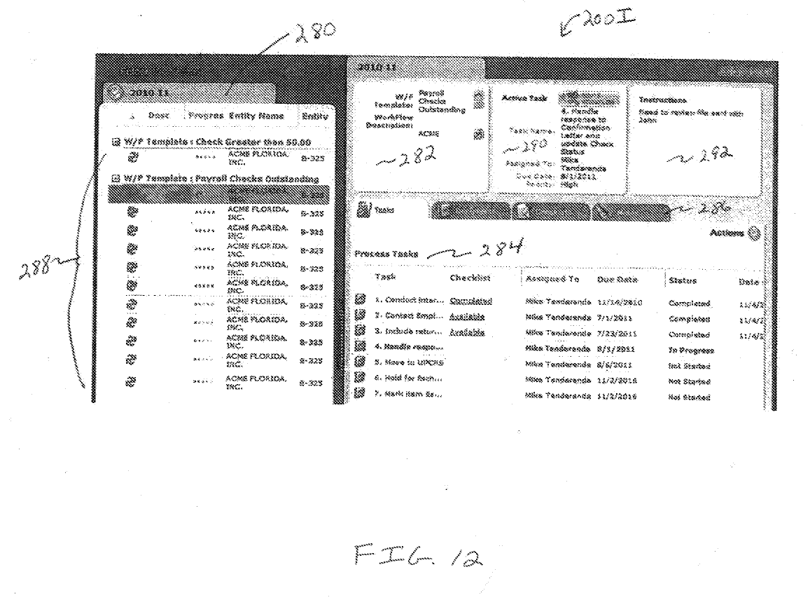

FIG. 12 illustrates an example workflow browser screen 200I provided by the interface module 34. The workflow browser screen 200I allows a user to access stored information in the data store 40 associated with a workflow process. As shown in FIG. 12, in one embodiment, one or more workflow process information sets may be stored in an electronic folder. The workflow browser screen 200I displays the name of the folder containing the one or more workflow processes 280, workflow field details 282, tasks associated with the one or more workflows 284, tabs 286 for various elements associated with a workflow, a selectable list of workflow processes 288 associated with the electronic folder, information regarding an active task 290 of a workflow, and any instructions 292 that may be directed toward a role implementer responsible for the active task of the one or more workflow processes.

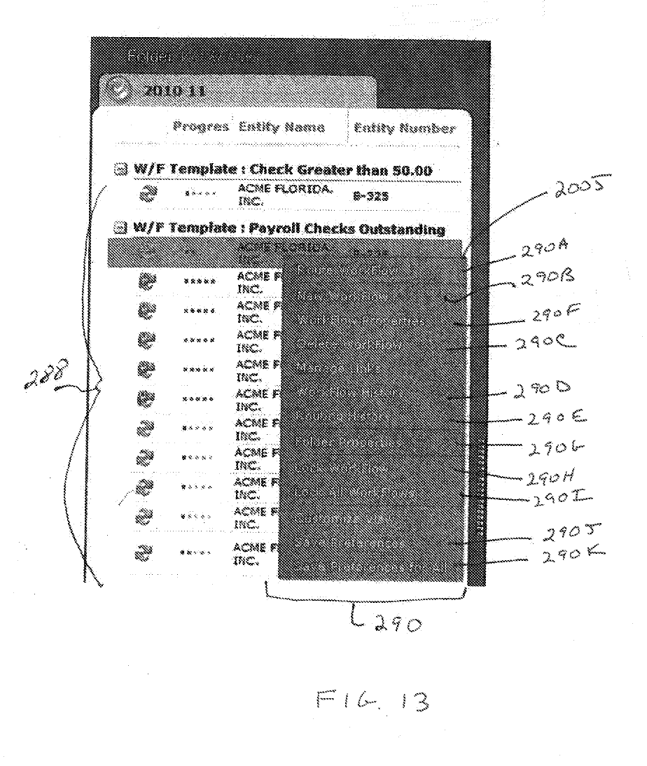

FIG. 13 shows a portion of the workflow browser screen 200I including an example action menu 200J provided by the interface module 34. As shown in the FIG. 13 example, the action menu 200J may be displayed by the interface module 34 upon selection of one of the selectable list of workflows 288. In one embodiment, selectable options 290 included in the action menu 200J may be restricted based on user system rights.

Selectable options 290 included in the action menu 200J provide functionality to affect workflow processes. For example, as shown in the FIG. 13 example, in one embodiment, selectable options include a route workflow option 290A that upon selection, routes a workflow to a role implementer, a new workflow option 290B that creates a new workflow process, a delete workflow option 290C that removes a workflow process from the system 10, as well as a workflow history option 290D and a routing history option 290E that display details regarding prior processing of workflows. Additional options include a workflow property and folder property options 290F, 290G that display attributes associated with a workflow process and workflow folder, respectively, lock options 290H, 2901 for causing one or more workflow processes to be read-only in the system 10, and preference options 290J, 290K for specifying the presentation of workflow process information in the system 10.

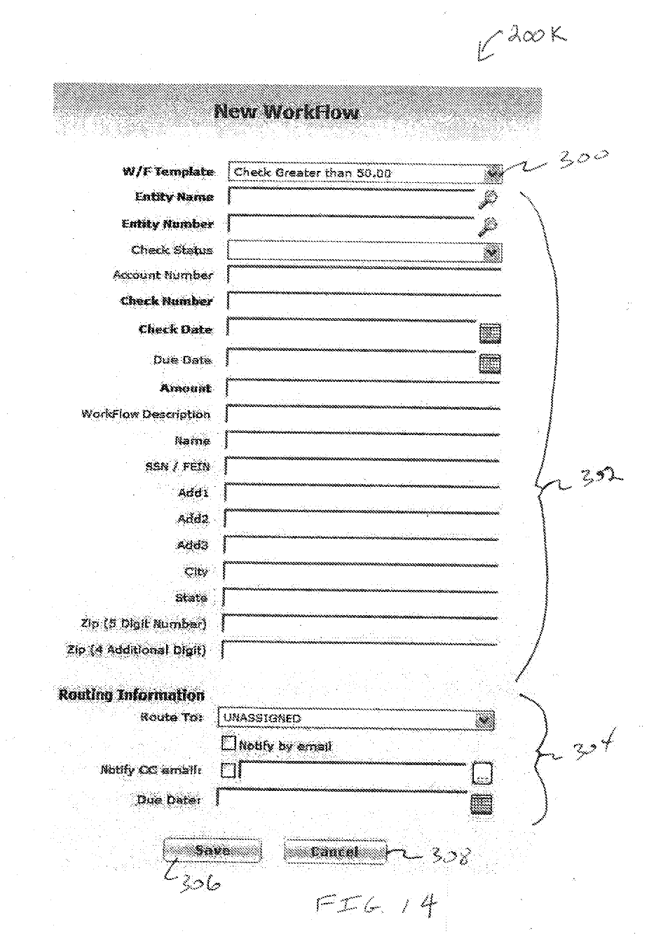

FIG. 14 illustrates an example create workflow screen 200K provided by the interface module 34. The create workflow screen 200K may be used by the user of the system to instantiate new workflow processes. As shown in the FIG. 14 example, in one embodiment, the create workflow screen 200K includes a template pull-down menu 300 allowing the user to select which set of pre-defined procedures are to be utilized by the workflow module 26 to instantiate the new workflow process. Additional data fields 302 and routing information 304 may also be specified for the new workflow process.

As shown in the FIG. 14 example, in one embodiment, a save button 306 is provide that once selected, causes the workflow module 26 to instantiate a new workflow process using information specified in the create workflow screen 200K. A cancel button 308 is also provided that once selected, causes the interface module 34 to close the create workflow screen 200K.

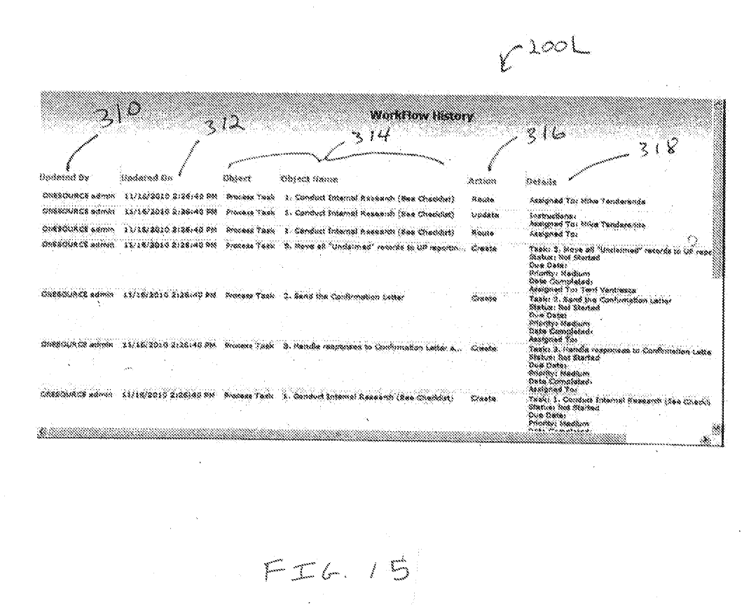

FIG. 15 illustrates an example workflow history screen 200L provided by the interface module 34. The workflow history screen 200L may be displayed to the user by the interface module 34 upon selection of the workflow history option 290D of the action menu 200J. As shown in the FIG. 15 example, in one embodiment, the workflow history screen 200L displays the name of the user 310 who updated the workflow, the date and time 312 of the update, the procedure type and name 314, the action taken on the procedure 316, and a description 318 of the actions taken.

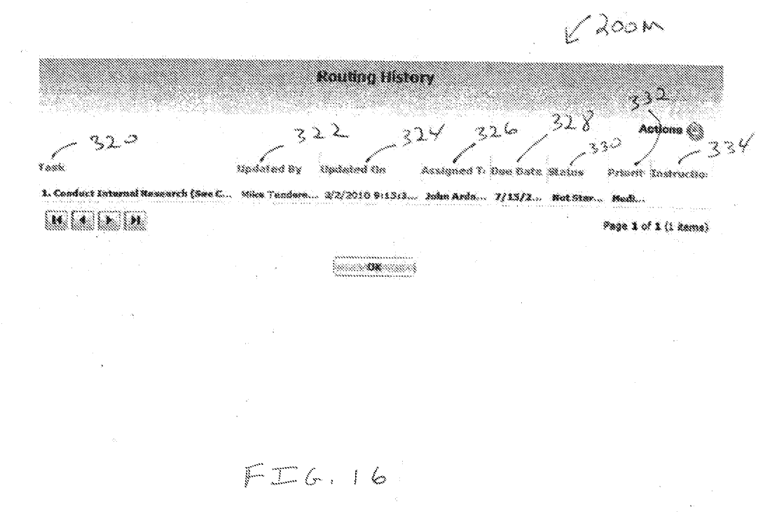

FIG. 16 illustrates an example routing history screen 200M provided by the interface module 34. The routing history screen 200M displays tasks associated with an instantiated workflow process that have been routed to role implementers. The routing history screen 200M may be displayed to the user by the interface module 34 upon selection of the routing history option 290E of the action menu 200J as shown in FIG. 13. In one embodiment, as shown in the FIG. 16 example, the routing history screen 200M displays task name 320, the name of the user who routed the task 322, the date and time 324 the task was routed, the name of the user the task was routed to 326, a due date 328, a status 330, priority 332, and any instruction 334 associated with the routed task.

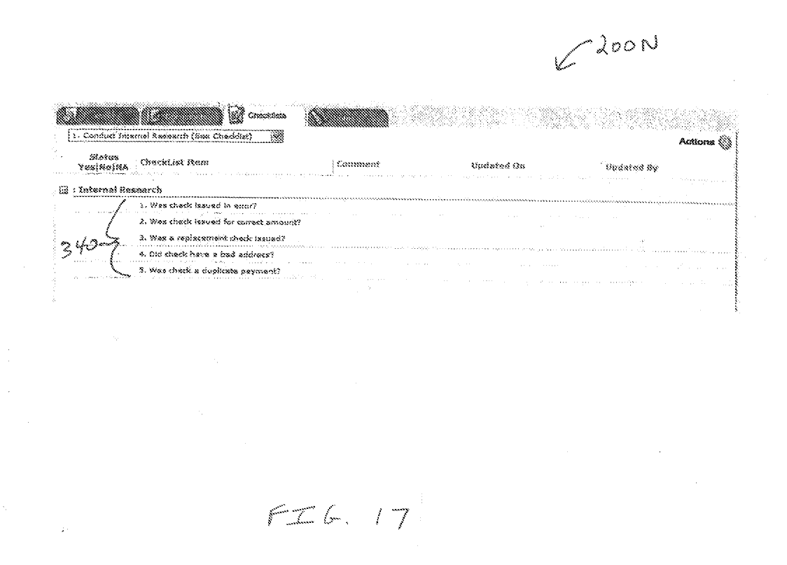

FIG. 17 illustrates an example checklist screen 200N provided by the interface module 34. The checklist screen 200N displays checklist items 340 that describe tasks or assignments within a larger task and/or workflow. In one embodiment, each checklist item 340 is associated with a status in a ‘Yes’, ‘No’, or ‘N/A’ format. By default, as shown in FIG. 17, the status of each checklist item 340 is blank until a response is entered.

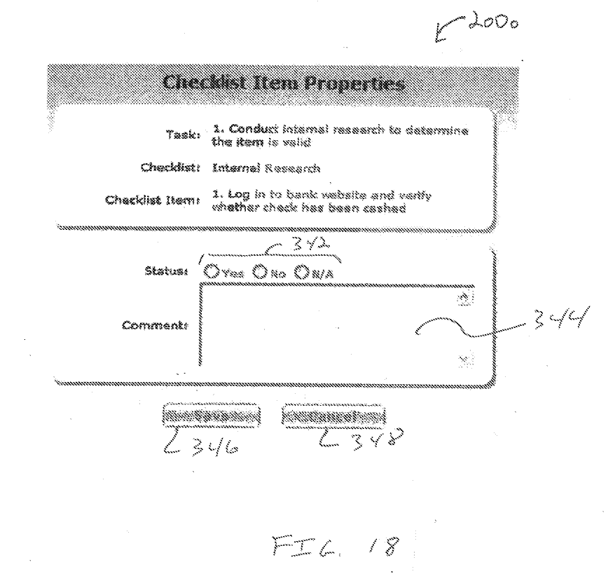

FIG. 18 illustrates an example checklist item screen 200O provided by the interface module 34. The checklist item screen 200O may be utilized by the user of the system to set a status for checklist items 340. For example, as shown in the FIG. 18 example, in one embodiment, radio buttons 342 are provided that allow the user to indicate the status for a checklist item and a text window 344 is provided that allows the user to enter comments regarding the checklist item. Upon selection of a provided save button 346, the workflow module 26 associates the set status and/or any entered comments with the checklist item. A cancel button 348 is also provided that once selected, causes the interface module 34 to close the checklist item screen 200O

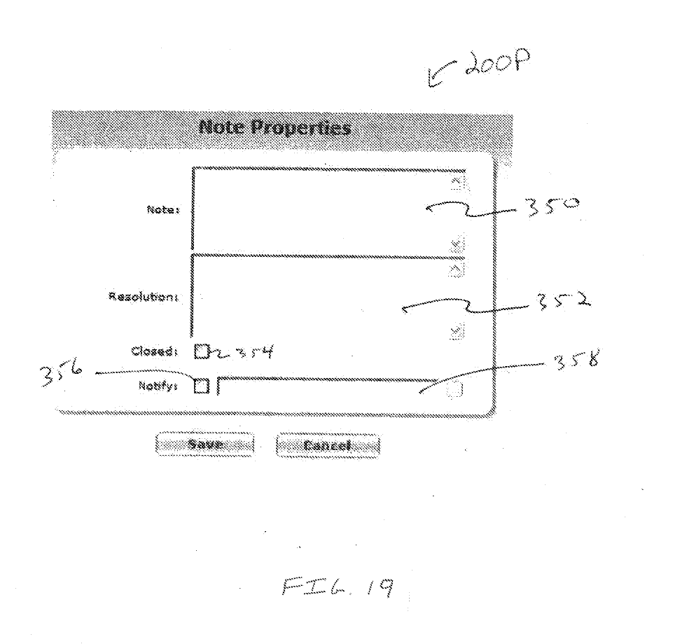

FIG. 19 illustrates an example note screen 200P provided by the interface module 34. The note screen 200P may be used by the user to either add a note to a workflow task or process or edit a note associated with a workflow task or process. The note may relate to a particular item of interest requiring resolution. As shown in the FIG. 19 example, in one embodiment, the note screen 200P includes a note text window 350 for entering and editing a note, a resolution text window 352 for entering any resolution to the item of interest, and a close checkbox 354 for indicating that the item of interest is resolved. As shown in the FIG. 19 example, the note screen 200P also includes a notify checkbox 356 and selection box 358 to indicate which user is to be notified of the resolution.

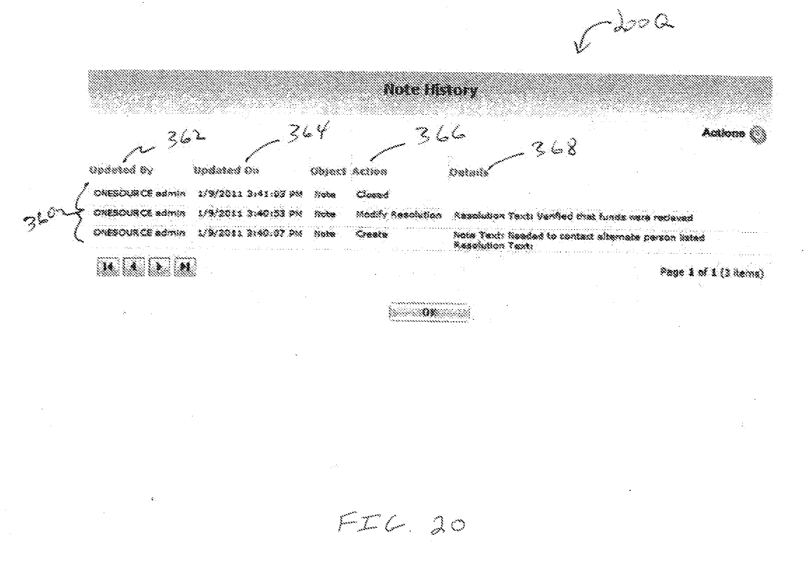

FIG. 20 illustrates an example note history screen 200Q provided by the interface module 34. The note history screen 200Q displays a listing of notes 360 associated with a workflow process. As shown in the FIG. 20 example, in one embodiment, the note history screen 200Q displays the name of the user who acted upon a note 362, a date and time 364 in which the note was acted upon, any action 366 taken upon the note, as well as details 368 regarding the action taken.

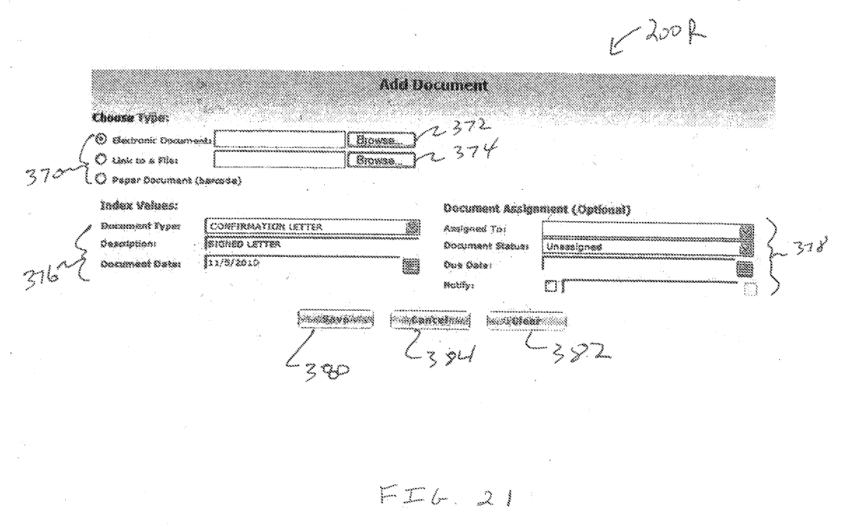

FIG. 21 illustrates an add document screen 200R provided by the interface module 34. The add document screen 200R allows the user to add electronic documents, links to a file, or paper documents to a task or workflow process. As shown in FIG. 21, in one embodiment, the add document screen 200R provides radio buttons 370 for identifying document types and browse buttons 372, 374 for selecting electronic documents and files to be linked. The user is also provided a set of selectable index options 376 that, once selected, may be used by the document module 28 to index and subsequently search for documents, and assignment options 378 that may be optionally set by the user to specify a role implementer assigned to the document.

The add document screen 200R also includes a save button 380 that, once selected, causes the workflow module 26 to associate the specified document or link with a task or workflow process. A clear button 382 is provided that, upon selection, removes any prior selections made by the user in the add document screen 200R, and a cancel button 384 is provided that, once selected, closes the add document screen 200R.

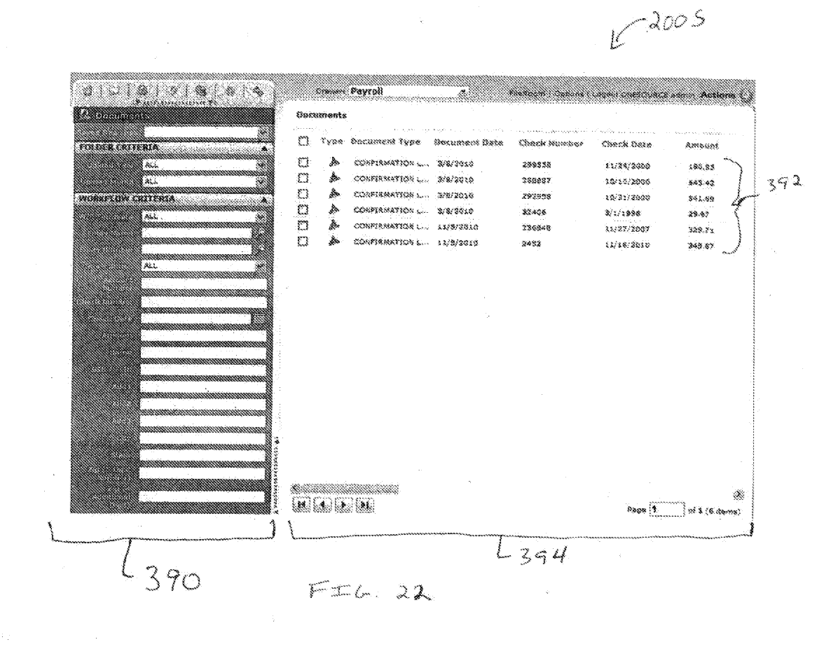

FIG. 22 illustrates an example document browser screen 200S provided by the interface module 34. The document browser screen 200S may be utilized by the user to access documents and any document links associated with a workflow process. In one embodiment, the document browser screen 200S includes a criteria portion 390 to specify criteria (e.g., attributes) associated with documents. The specified criteria is utilized by the document module 28 to search and retrieve documents.

In one embodiment, as shown in FIG. 22, documents identified by the document module 28 are displayed as document list items 392 along with specified criteria in a document display portion 394 of the document browser screen 200S. Selection of any one of the document list items 392 displays content of the document.

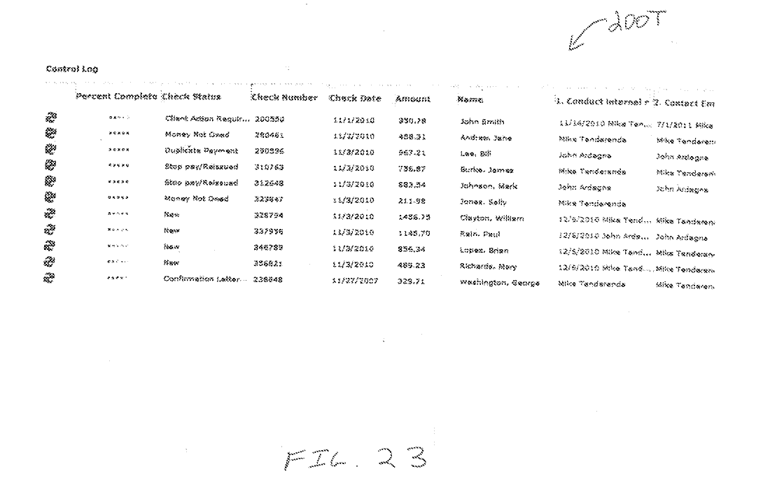

FIG. 23 illustrates an example control log screen 200T provided by the interface module 34. The control log screen displays the status of all tasks in a workflow process as recorded and maintained by the workflow module 26.

Various features of the system may be implemented in hardware, software, or a combination of hardware and software. For example, some features of the system may be implemented in one or more computer programs executing on programmable computers. Each program may be implemented in a high level procedural or object-oriented programming language to communicate with a computer system or other machine. Furthermore, each such computer program may be stored on a storage medium such as read-only-memory (ROM) readable by a general or special purpose programmable computer or processor, for configuring and operating the computer to perform the functions described above.

What is claimed is:

1. A method of managing unclaimed property comprising:
providing an electronic workflow for association with a potentially unclaimed asset associated with an entity, the electronic workflow comprising a set of pre-defined procedures for processing the potentially unclaimed asset;
based upon completion of at least one procedure from the set of pre-defined procedures, determining whether a communication with a governmental authority is necessary; and
if the communication is necessary, automatically generating a set of unclaimed property forms for submission to the governmental authority, and
if the communication is unnecessary, automatically terminating the electronic workflow.

2. The method of claim 1, further comprising tracking a status associated with each procedure included in the set of pre-defined procedures.

3. The method of claim 1, wherein at least one procedure of the set of pre-defined procedures comprises transmitting a communication to the entity.

4. The method of claim 3, comprising determining whether the potentially unclaimed asset is to be communicated to the governmental authority based on a response to the communication or no response to the communication.

5. The method of claim 4, comprising associating a document indicative of the response with at least one procedure of the set of pre-defined procedures.

6. The method of claim 4, comprising associating a note with at least one procedure of the set of procedures.

7. The method of claim 4, comprising associating a checklist with at least one procedure of the set of procedures

8. The method of claim 1, wherein the potentially unclaimed asset is accessed from at least one of a payroll data store, an account payable data store, an account receivable data store, a garnishment data store, and an IT audit data store.

9. The method of claim 1, wherein at least one procedure of the set of pre-defined procedures is assigned to a role, the role associated with a role implementer.

10. The method of claim 9, further comprising routing the at least one procedure of the set of pre-defined procedures to the role implementer.

11. The method of claim 1, further comprising transmitting a due diligence letter to the entity in response to the potentially unclaimed asset pending greater than a first pre-determined time interval.

12. The method of claim 11, comprising automatically generating the due diligence letter.

13. The method of claim 10, comprising determining whether a response to the due diligence letter is received from the entity over a second pre-determined time interval.

14. The method of claim 13, further comprising associating the response to the due diligence letter with one procedure of the set of pre-defined procedures.

15. The method of claim 13, comprising generating the set of unclaimed property forms upon expiration of a second pre-determined time interval.

16. The method of claim 11, comprising updating a status of one procedure of the pre-defined procedures to indicate transference of the unclaimed asset to the governmental authority.

17. The method of claim 16, comprising storing the set of unclaimed property forms and proof of transference in an electronic document repository.

18. The method of claim 1, further comprising providing a graphical user interface for completing the at least one procedure included in the set of pre-defined procedures.

19. A system for managing unclaimed property comprising:
a set of pre-defined procedures for processing a potentially unclaimed asset associated with an entity;
a workflow module to manage and execute at least one procedure of the set of pre-defined procedures; and
a filing module to generate a set of unclaimed property forms for submission to a governmental authority in response to completion of the at least one procedure included in the set of pre-defined procedures.

20. The system of claim 19, wherein the workflow module tracks a status associated with each procedure included in the set of pre-defined procedures.

21. The system of claim 19, wherein the workflow module transmits a communication to the entity associated with the potentially unclaimed asset.

22. The system of claim 21, wherein the workflow module determines whether the potentially unclaimed asset is to be reported to the governmental authority based on a response to the communication or no response to the communication.

23. The system of claim 22, further comprising a document module to associate a document indicative of the response with at least one procedure of the set of pre-defined procedures.

24. The system of claim 23, wherein the document module associates a note with at least one procedure of the set of procedures.

25. The system of claim 23, wherein the document module associates a checklist with at least one procedure of the set of procedures

26. The system of claim 19, wherein the potentially unclaimed transaction is accessed from a least one of a payroll data store, an account payable data store, an account receivable data store, a garnishment data store, and an IT audit data store.

27. The system of claim 19, wherein the workflow module assigns a role to a role implementer.

28. The system of claim 19, wherein the workflow module routes the at least one procedure of the set of pre-defined procedures to the role implementer.

29. The system of claim 19, wherein the workflow module transmits a due diligence letter to the entity in response to the potentially unclaimed asset pending greater than a first pre-determined time interval.

30. The system of claim 29, wherein the filing module automatically generates the due diligence letter.

31. The system of claim 29, wherein the workflow module determines whether a response to the due diligence letter is received from the entity over a second pre-determined time interval.

32. The system of claim 31, wherein the document module associates the response to the due diligence letter with one procedure of the set of pre-defined procedures.

33. The system of claim 31, wherein the filing module generates the set of unclaimed property forms upon expiration of a second pre-determined time interval.

34. The system of claim 29, wherein the workflow module updates a status of one procedure of the pre-defined procedures to indicate transference of the unclaimed transaction to the governmental authority.

35. The system of claim 34, wherein the filing module stores the set of unclaimed property forms and proof of transference in an electronic document repository.

36. The system if claim 19, further comprising an interface module, the interface module providing a graphical user interface for completing that at least one procedure of the set of pre-defined procedures.

37. A system for managing unclaimed property comprising:
means for providing an electronic workflow for association with a potentially unclaimed transaction associated with an entity, the electronic workflow comprising a set of pre-defined procedures for processing the potentially unclaimed transaction;
means for determining whether the potentially unclaimed transaction is an unclaimed transaction based upon completion of at least one procedure included in the set of pre-defined procedures; and
means for generating a set of unclaimed property forms for submission to a governmental authority in response to the completion of the at least one procedure included in the set of pre-defined procedures.
